(19) United States
(12) Patent Application Publication
(10) Pub. No.: US 2014/0085232 A1
(43) Pub. Date: Mar. 27, 2014

(54) INFORMATION PROCESSING DEVICE AND DISPLAY CONTROL METHOD

(71) Applicant: Kabushiki Kaisha Toshiba, Tokyo (JP)

(72) Inventor: Takuya Ootani, Ome-shi (JP)

(21) Appl. No.: 13/911,593

(22) Filed: Jun. 6, 2013

(30) Foreign Application Priority Data
Sep. 26, 2012 (JP) 2012-213048

(51) Int. Cl. G06F 3/041

(52) U.S. Cl. CPC G06F 3/041
USPC 345/173

(57) ABSTRACT

According to one embodiment, an information processing device includes: a calculator configured to calculate a screen operation position on a screen in accordance with a detection result of a touch operation position on a touch device; a second calculator configured to calculate a predicted screen operation position on the screen taking into account a predetermined calculation time required for the calculation of the screen operation position after the detection of the touch operation position based on the screen operation position; and a generator configured to generate image data to be displayed on the screen based on the predicted screen operation position.

### CROSS-REFERENCE TO RELATED APPLICATIONS

This application is based upon and claims the benefit of priority from Japanese Patent Application No. 2012-213048, filed Sep. 26, 2012, the entire contents of which are incorporated herein by reference.

### FIELD

Embodiments described herein relate generally to an information processing device and a display control method.

### BACKGROUND

In a conventional device having a touch device such as a touch panel display or a pen tablet, when a touch operation position on such a touch device is detected, a screen operation position on a screen is calculated from the detected touch operation position. Based on a difference between the calculated screen operation positions, the screen is updated to adapt scrolling of the screen and movement of dragged items.

In the conventional technology, however, a screen is updated based on a screen operation position on a screen obtained when a touch operation position on a touch device is detected. This leads to an increase in error between the present touch operation position and the calculated screen operation position, and reduces tracking capability of display contents on the screen to follow a touch operation position on a touch sensor, in such a device that requires time between detection of a touch operation position on the screen and calculation of a screen operation position on the screen.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating the appearance of a PDA as an information processing device according to an embodiment;

FIG. 2 is an exemplary block diagram illustrating the principal configuration of the PDA as an information processing device in the embodiment;

FIG. 3 is an exemplary block diagram illustrating the functional configuration of the PDA as an information processing device in the embodiment;

FIG. 4 is an exemplary flowchart illustrating the flow of calculation processing of operation position coordinates processed by a touch information processor of the PDA as an information processing device in the embodiment; and

FIG. 5 is an exemplary flowchart illustrating the flow of image data generation processing processed by a drawing controller of the PDA as an information processing device in the embodiment.

### DETAILED DESCRIPTION

In general, according to one embodiment, an information processing device comprises: a calculator configured to calculate a screen operation position on a screen in accordance with a detection result of a touch operation position on a touch device; a second calculator configured to calculate a predicted screen operation position on the screen taking into account a predetermined calculation time required for the calculation of the screen operation position after the detection of the touch operation position based on the screen operation position; and a generator configured to generate image data to be displayed on the screen based on the predicted screen operation position.

Hereinafter, an information processing device and a display control method according to the present embodiment will be described with reference to the attached drawings.

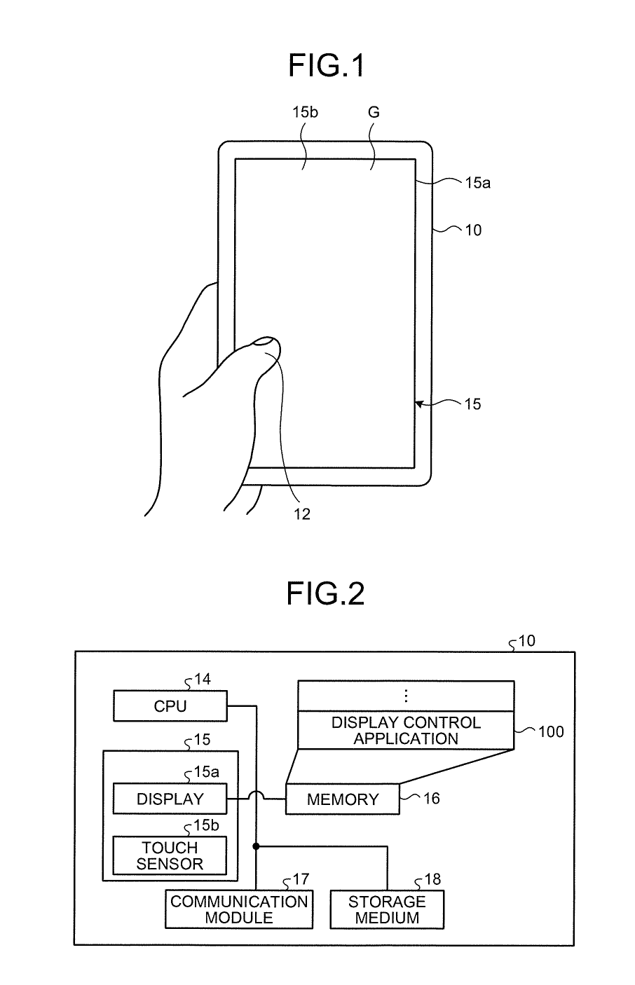

FIG. 1 is a view illustrating the appearance of a PDA as an information processing device according to the present embodiment. In the present embodiment, the information processing device is embodied as a personal digital assistant (PDA) 10 comprising a touch panel display that incorporates a display 15a as a display module and a touch sensor 15b. The display 15a comprises a screen G on which image data is displayed. The touch sensor 15b is stacked on the screen G.

As illustrated in FIG. 1, the PDA 10 comprises a touch panel display 15 that incorporates the touch sensor 15b. The touch panel display 15 allows display contents on the screen G of the display 15a to be selected and updated through a touch operation on the screen G performed by a finger 12, a touch pen, or the like.

FIG. 2 is a block diagram illustrating the principal configuration of the PDA as an information processing device in the present embodiment. The PDA 10 comprises a central processing unit (CPU) 14, the touch panel display 15, a memory 16, a communication module 17, and a storage medium 18.

The CPU 14 is a controller that collectively controls each device in the PDA 10. The CPU 14 loads an operating system (OS) and various applications such as a display control application 100 and the like that are stored in the storage medium 18 into the memory 16 to perform control.

The memory 16 is a storage medium such as a read only memory (ROM), a random access memory (RAM), and a flash memory.

The touch panel display 15 is a display device incorporating the display 15a and the touch sensor 15b. The display 15a comprises the screen G on which image data to be displayed is displayed. The touch sensor 15b detects a touch operation performed by the finger 12 of a user, a touch pen, or the like.

The storage medium 18 is a storage medium with a larger capacity than that of the memory 16 such as a flash memory, such as a hard disk drive (HDD). The storage medium 18 stores therein the OS and various applications.

The communication module 17 is a connection interface to be connected to the Internet or the like.

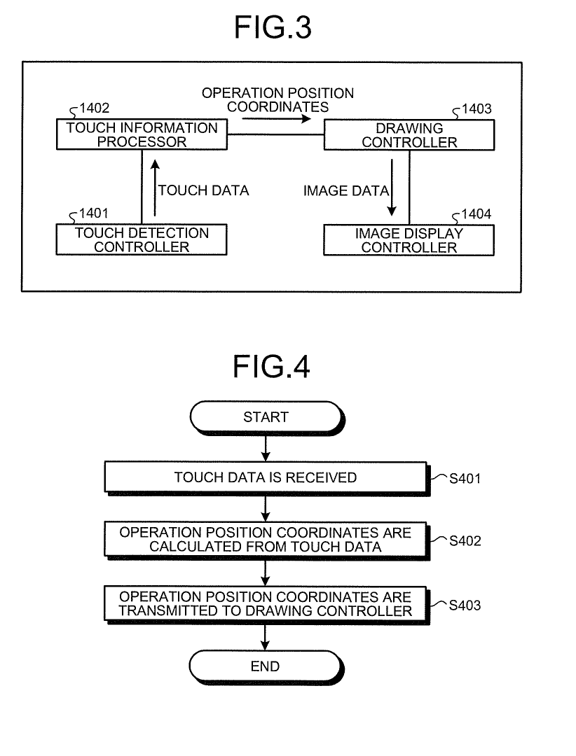

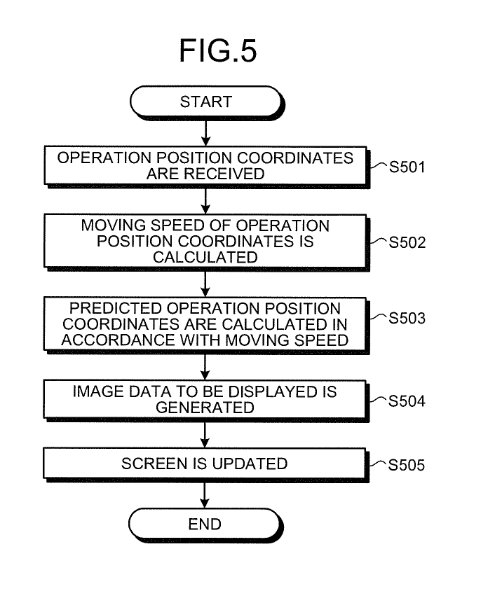

Next, processing of updating display contents on the screen G of the PDA 10 according to the present embodiment will be described with reference to FIGS. 3 to 5. FIG. 3 is a block diagram illustrating a functional configuration of the PDA as an information processing device according to the present embodiment. FIG. 4 is a flowchart illustrating the flow of calculation processing of a screen operation position performed by a touch information processor of the PDA as an information processing device according to the present embodiment. FIG. 5 is a flowchart illustrating the flow of image data generation processing performed by a drawing controller of the PDA as an information processing device according to the embodiment.

A touch detection controller 1401 detects a touch operation position by a touch operation performed by the finger 12 of the user, a touch pen, or the like on the touch sensor 15b. In the present embodiment, the touch detection controller 1401 detects a touch operation position on the touch sensor 15b with a predetermined detection period. The touch detection controller 1401, each time it detects a touch operation position, transmits touch data including the coordinates of the detected touch operation position (hereinafter referred to as the touch coordinates) to a touch information processor 1402.

The touch information processor 1402 functions as a calculator for calculating a screen operation position on the screen G in accordance with a detection result of touch operation positions obtained by the touch detection controller 1401. In the present embodiment, as illustrated in FIG. 4, the touch information processor 1402, each time the touch detection controller 1401 detects a touch operation position, receives the touch data from the touch detection controller 1401 (S401).

Next, the touch information processor 1402, on the basis of the touch coordinates included in the received touch data, calculates the coordinates of the screen operation position on the screen G (hereinafter, referred to as the operation position coordinates) (S402). In the present embodiment, the touch sensor 15b is stacked on the screen G. Thus, the touch information processor 1402 calculates the touch operation position detected by the touch detection controller 1401 as the screen operation position on the screen G as it is. When a touch operation position detected by the touch detection controller 1401 is, for example, a touch operation position on a touch pad provided separately from the screen G, the touch information processor 1402 converts the detected touch operation position into a screen operation position on the screen G in accordance with the size of the screen G.

The touch information processor 1402 then transmits the calculated operation position coordinates to a drawing controller 1403 (S403).

The drawing controller 1403 functions as a second calculator that, on the basis of the screen operation position calculated by the touch information processor 1402, calculates a predicted screen operation position on the screen G taking into account a predetermined time required between detection of the touch operation position by the touch detection controller 1401 and calculation of the screen operation position by the touch information processor 1402 (hereinafter referred to as the calculation time). In other words, the drawing controller 1403 regards a screen operation position lately calculated by the touch information processor 1402 as a past screen operation position, and using the screen operation position lately calculated, calculates a predicted screen operation position at the present time. The drawing controller 1403 functions as a generator for generating image data to be displayed on the screen G in accordance with the calculated predicted screen operation position.

In the present embodiment, as illustrated in FIG. 5, the drawing controller 1403 receives the operation position coordinates calculated by the touch information processor 1402 (S501). The drawing controller 1403 then calculates the moving speed of the operation position coordinates on the screen G on the basis of a plurality of operation position coordinates received from the touch information processor 1402 (S502). Specifically, the drawing controller 1403 stores therein a few dozens to a few hundreds of latest operation position coordinates calculated by the touch information processor 1402. The drawing controller 1403 calculates the moving speed of the operation position coordinates using the plurality of operation position coordinates lately calculated and times required for calculation of the plurality of operation position coordinates. Alternatively, the drawing controller 1403 may calculate the moving speed by performing polynomial approximation by the least square method or the like using a few tens to few hundreds of operation position coordinates lately calculated.

The drawing controller 1403 calculates operation position coordinates when the operation position coordinates calculated by the touch information processor 1402 have moved at the calculated moving speed for a predetermined calculation time, as predicted operation position coordinates (a predicted screen operation position) (S503). In other words, the drawing controller 1403 corrects the screen operation position (the operation position coordinates) calculated by the touch information processor 1402 on the basis of the predetermined calculation time and the calculated moving speed, whereby calculating the predicted screen operation position (the predicted operation position coordinates). The predetermined calculation time is, as described above, a predetermined time required between detection of the touch operation position by the touch detection controller 1401 and calculation of the screen operation position by the touch information processor 1402 (for example, 60 to 80 ms). In the present embodiment, the calculation time varies in accordance with a time required for calculation of the screen operation position by a kernel and wiring that connects the touch sensor 15b and the CPU 14. Thus, the calculation time is predetermined for each information processing device that performs processing of calculating a screen operation position on the screen G from detection of a touch operation position performed by the touch sensor 15b.

The drawing controller 1403 sets a longer predetermined calculation time as the calculated moving speed increases. When the calculated moving speed is low (for example, immediately after the finger 12 starts moving on the screen G), the calculated predicted screen operation position may exceed the screen operation position at the present time if a predicted screen operation position is calculated as a screen operation position resulting after displacement at the calculated moving speed for a predetermined calculation time. To address this, the drawing controller 1403 extends further the predetermined calculated time as the calculated moving speed increases. When the calculated moving speed has reached a predetermined value (for example, 1 pix/s), the drawing controller 1403 sets the predetermined calculated time to be a constant time (for example, 80 ms). This allows calculation of a predicted screen operation position that is close to the screen operation position at the present time, even when the moving speed of the screen operation position has changed.

The drawing controller 1403 generates image data to be displayed in accordance with the calculated predicted screen operation position (S504). For example, the drawing controller 1403 generates image data that is scrolled to place the calculated predicted screen operation position at the center of the screen G, generates image data in which a dragged item has moved to predicted display coordinates on the screen G, or generates image data drawing a trajectory along which the calculated operation position coordinates have moved.

A screen display controller 1404 updates display contents on the screen G in accordance with the image data generated by the drawing controller 1403 with an updating period of updating display contents on the screen G (S505).

The PDA 10 according to the present embodiment thus calculates a screen operation position on the screen G in accordance with a detection result of a touch operation position on the touch sensor 15b, calculates a predicted screen position on the screen G taking into account a predetermined calculation time required between detection of the touch operation position and calculation of the screen operation position on the basis of the calculated screen operation position, and generates image data to be displayed on the screen on the basis of the predicted screen operation position. This can reduce an error between the present touch operation position and the calculated screen operation position in such a device that requires time between detection of a touch operation position on the screen and calculation of a screen operation position on the screen G. This thus improves tracking capability of display contents on the screen G to follow a touch operation position on the touch sensor 15b.

Although the present embodiment has been described for the PDA 10 with the touch sensor 15b integrated, it may be applied to an information processing device (for example, a display) that receives a touch operation position from a touch device that is not integrated with the own device, such as a touch pad or a pen tablet, and generates image data to be displayed on the screen G on the basis of the received touch operation position. The touch device such as a touch pad or a pen tablet comprises the touch detection controller 1401 and the touch information processor 1402. The touch detection controller 1401 detects a touch operation position on the screen G. The touch information processor 1402 calculates a screen operation position on the screen G in accordance with the detection result of the touch operation position on the touch device. The information processing device comprises the drawing controller 1403. The drawing controller 1403 calculates a predicted screen position on the screen G taking into account a predetermined calculation time required between detection of the touch operation position and calculation of the screen operation position on the basis of the calculated screen operation position, and generates image data to be displayed on the screen G on the basis of the calculated predicted screen operation position.

Computer programs to be run on the PDA 10 of the present embodiment is incorporated into a ROM or the like in advance to be provided.

The programs to be run on the PDA 10 of the present embodiment may be configured to be recorded on a computer-readable recording medium such as a CD-ROM, a flexible disk (FD), a CD-R, and a digital versatile disk (DVD), as a file in an installable form or an executable form.

The programs to be run on the PDA 10 of the present embodiment may be configured to be stored on a computer that is connected to a network such as the Internet and to be provided by download through the network. The programs to be run on the PDA 10 of the present embodiment maybe configured to be provided or distributed through a network such as the Internet.

The programs to be run on the PDA 10 of the present embodiment are a module configuration comprising the above-described parts (the touch detection controller 1401, the touch information processor 1402, the drawing controller 1403, and the screen display controller 1404). As actual hardware, the CPU (processor) reads out the programs from the ROM and executes them, thereby allowing the above-described parts to be loaded into a main storage and allowing the touch detection controller 1401, the touch information processor 1402, the drawing controller 1403, and the screen display controller 1404 to be generated on the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a calculator configured to calculate a screen operation position on a screen in accordance with a detection result of a touch operation position on a touch device;
a second calculator configured to calculate a predicted screen operation position on the screen taking into account a predetermined calculation time required for the calculation of the screen operation position after the detection of the touch operation position based on the screen operation position; and
a generator configured to generate image data to be displayed on the screen based on the predicted screen operation position.

2. The information processing device of claim 1, wherein the second calculator is configured to correct the screen operation position based on the predetermined calculation time and a moving speed of the screen operation position to calculate the predicted screen operation position.

3. The information processing device of claim 2, wherein the second calculator is configured to set the calculation time to be longer as the moving speed increases.

4. A display control method performed in an information processing device, the display control method comprising:
calculating a screen operation position on a screen in accordance with a detection result of a touch operation position on a touch device by a calculator in the information processing device;
calculating a predicted screen operation position on the screen taking into account a predetermined calculation time required for the calculation of the screen operation position after the detection of the touch operation position based on the screen operation position by a second calculator in the information processing device; and
generating image data to be displayed on the screen based on the predicted screen operation position by a generator in the information processing device.
